(19) United States
(12) Patent Application Publication
(10) Pub. No.: US 2025/0123248 A1
(43) Pub. Date: Apr. 17, 2025

(54) ONLINE AND OFFLINE MEASUREMENTS OF GLYCOLS STRENGTHS WITH ANALYSIS PROCEDURE

(71) Applicant: SAUDI ARABIAN OIL COMPANY, Dhahran (SA)

(72) Inventors: Mohamed Ahmed Saad Mahmoud, Dammam (SA); Ahmed Hamad Al-Salman, Dhahran (SA); Hassan Yahya Al-Malki, Dhahran (SA)

(73) Assignee: SAUDI ARABIAN OIL COMPANY, Dhahran (SA)

(21) Appl. No.: 18/485,099

(22) Filed: Oct. 11, 2023

(51) Int. Cl. G01N 30/68; G01N 1/00; G01N 25/14; G01N 30/02; G01N 31/16; G01N 35/00

(52) U.S. Cl. CPC G01N 30/68; G01N 25/142; G01N 31/168; G01N 2001/002; G01N 2030/025; G01N 2035/00207

(57) ABSTRACT

A method for measuring the purity of a glycol sample includes measuring the purity of the glycol sample via gas chromatography, measuring the purity of the glycol sample via evaporation, measuring the purity of the glycol sample via titration, and comparing the purity of the glycol sample from gas chromatography, evaporation, and titration to obtain an accurate purity. A system for measuring the purity of a glycol sample in a pipeline includes at least one type of testing equipment connected to the pipeline via at least one test line and an interfacial online data processor in communication with the at least one type of testing equipment. The at least one type of testing equipment includes a gas chromatography instrument, an evaporation instrument, and a titration instrument.

### BACKGROUND

Glycol is an important additive in the gas production industry. Derivatives of glycol employed in the gas industry include monoethylene glycol (MEG) and triethylene glycol (TEG). MEG is injected along with the common producing line at offshore facilities to prevent hydrate formations. TEG is used as a liquid desiccant for the removal of formed or associated water from natural gas and natural gas liquids to avoid hydrate formation during gas transportation and refining.

Accordingly, there exists a need for measuring the purity of glycol derivatives. Measuring the purity of glycol used in the gas production industry is needed to determine the proper action to protect the pipelines and meet production specifications. Verifying that the purity of MEG and TEG is accurate is crucial to prevent hydrate formation and reduce glycol losses during regeneration processes.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for measuring a purity of a glycol sample. The method may include measuring the purity of the glycol sample via gas chromatography, measuring the purity of the glycol sample via evaporation, and measuring the purity of the glycol sample via titration. The method may then include comparing the purity of the glycol sample from gas chromatography, evaporation, and titration to obtain an accurate purity.

In another aspect, embodiments disclosed herein relate to a system for measuring a purity of a glycol sample in a pipeline. The system may include at least one type of testing equipment connected to the pipeline via at least one test line and an interfacial online data processor in communication with the at least one type of testing equipment. The at least one type of testing equipment may include a gas chromatography instrument, an evaporation instrument, and a titration instrument.

Other aspects and advantages of the claimed subject matter will be apparent from the following description and the appended claims.

### BRIEF DESCRIPTION OF DRAWINGS

FIG. 1 is a schematic of a system for measuring the purity of a glycol sample, in accordance with one or more embodiments.

FIG. 2 is a flowchart of a method for measuring the purity of a glycol sample, in accordance with one or more embodiments.

FIG. 3 is an example overlay of a plurality of peak areas of MEG, in accordance with one or more embodiments.

FIG. 4 is an example calibration curve of MEG, in accordance with one or more embodiments.

FIG. 5 is an example gas chromatograph of TEG, in accordance with one or more embodiments.

FIG. 6 is an example calibration curve of TEG, in accordance with one or more embodiments.

### DETAILED DESCRIPTION

In one aspect, embodiments disclosed herein relate to a system and method for measuring the purity of a glycol sample. Derivatives of glycol, such as monoethylene glycol (MEG), diethylene glycol (DEG), and triethylene glycol (TEG), may be used in the gas production industry to prevent hydrate formation. Hydrates may include molecules of a light hydrocarbon surrounded by a crystal structure of water molecules. A light hydrocarbon may include a carbon length of two or less. Hydrates may also include carbon dioxide and hydrogen disulfide surrounded by the crystal structure of water. The formation of hydrates may lead to corrosion as well as plugging of the pipelines.

MEG may be added directly into the common producing line at offshore gas production facilities to prevent hydrate formations. MEG is known to prevent hydrate formation by reducing the hydrate formation temperature in the common producing line.

TEG may be used as a liquid desiccant to remove water from gas at onshore facilities. TEG is known to remove water by physical adsorption of water and water vapor present in natural gas.

Embodiments disclosed herein generally relate to a system for measuring a purity of a glycol sample in a pipeline. The system may include at least one type of testing equipment, at least one test line, and an interfacial online data processor. Embodiments disclosed herein also relate to a method for measuring a purity of a glycol sample.

As noted above, the gas production industry may add glycol to prevent hydrate formation. Glycol may be added directly from a pipeline into a production line for gas production. Glycol may also be added at a different point in the gas production, such as during transportation. Glycol may include glycol derivatives. In one or more embodiments, the glycol derivates are MEG or TEG.

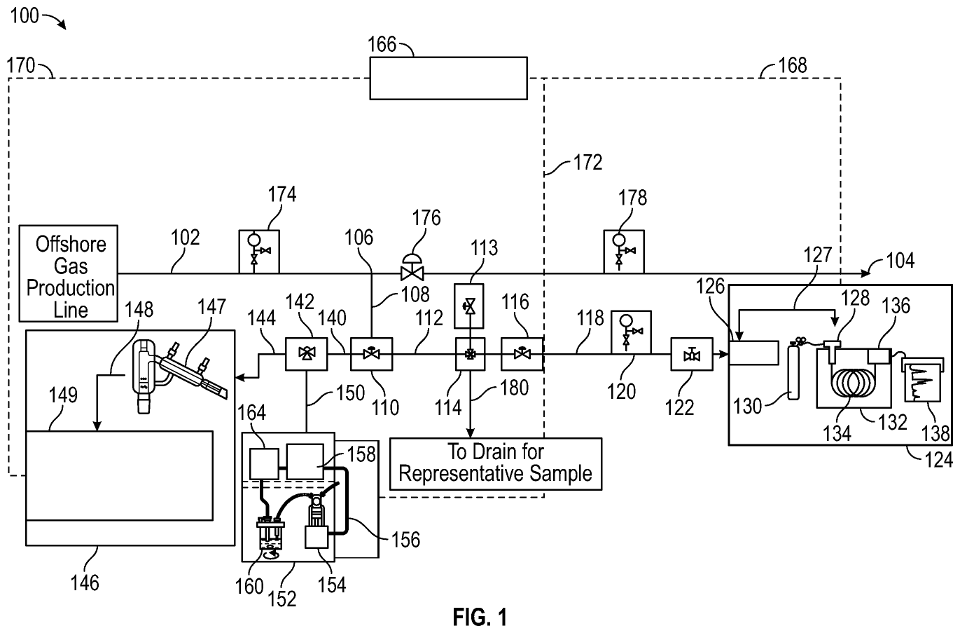

According to one or more embodiments, FIG. 1 is a schematic of a system for measuring the purity of a glycol sample in a pipeline. The system 100 is configured to feed glycol from the pipeline 102 to at least one type of testing equipment via at least one test line. The at least one type of testing equipment includes a gas chromatography instrument 124, an evaporation instrument 146, and a titration instrument 152. The system is configured to communicate between an interfacial online data processor 166 and the at least one type of testing equipment. FIG. 1 shows an example of a system having the testing equipment (124, 146, and 152) assembled at a site of production and online with a production line. However, in one or more embodiments, as described in more detail below, testing equipment may be used offline (e.g., not connected to a production line) and/or at a site remote from the production line.

Pipeline 102 may be a pipeline present at an offshore gas production system and may be used to supply glycol to a production line. Pipeline 102 may be configured to have a sample probe 106 at a 3 o'clock position extending into a mid-flow point of pipeline 102 to enable withdrawing of a representative sample into test line 108. As used herein, a 12-hr clock position reference may be used to identify relative locations around a cross-sectional view of the pipeline when viewed from an upstream perspective, where the 12 o'clock position refers to the gravitational uppermost/top point along the pipeline. Thus, a 3 o'clock position may refer to a side location around the perimeter of the pipe. The sample probe 106 may be positioned on the pipeline 102 before the glycol consumption point 104. The system 100 may be aligned to flow glycol through test lines 108, 112, and 118 by the opening of manual valves 110 and 116 and 4-way valve 114. Pressure indicator 120 may be positioned to measure the pressure of the glycol flowing through test line 118.

Test line 118 may be configured to feed glycol through an opening of a needle valve 122 to an autosampler 126. Test line 127 may then be aligned to feed the glycol from the autosampler 126 into a gas chromatography instrument 124. The gas chromatography instrument 124 may be connected to the pipeline 102 (e.g., directly or indirectly through multiple valves and test lines) to bring the gas chromatography instrument 124 online with the system 100. In one or more embodiments, the gas chromatography instrument 124 may be installed online in the system 100 at an offshore MEG injection skid. In one or more embodiments, the gas chromatography instrument 124 may be installed online in the system 100 at the return line of lean TEG in a gas dehydration system before contacting the feed gas.

Lean TEG, with respect to the present disclosure, is TEG with a low water content (i.e., less than 1.5 vol. %) which is able to adsorb water from the feed gas. Feed gas, with respect to the present disclosure, is untreated gas from an onshore or offshore production well which is known to have a high amount of associated water. The gas dehydration system may be configured to contact the feed gas with the lean TEG to remove water from the feed gas, e.g., before the feed gas undergoes refining and fractionation processes. For example, a gas dehydration system may include a column of a glycol absorber including lean TEG, where a feed gas may be directed through the bottom of the column to have water removed therefrom and output dry gas. The gas dehydration system may reduce the water content to be equal to or less than 150 parts per million (ppm) or 7 pounds per million standard cubic feet of gas (lbs/MMSCF).

The autosampler 126 may dilute the glycol sample to a concentration suitable for use in the gas chromatography instrument 124. The dilution may range from 5 to 20 fold by volume. In one or more embodiments, the dilution is a 20 fold dilution by volume where deionized water is the solvent.

The gas chromatography instrument 124 may be configured so that diluted glycol sample is fed into an injector 128 (e.g., via one or more connection lines). The injector 128 is set up to inject the diluted glycol sample into the gas chromatography instrument 124. The injector may be a direct injector or a split/splitless injector. The injector may be heated. The heating temperature may be in a range from 170 to 240° C. In one or more embodiments, the injection is done automatically by the autosampler 126 at a temperature of 180° C.

The system 100 may be configured to move the diluted glycol sample through a column 134 in the gas chromatography instrument 124. The column 134 is used to separate the MEG or TEG from the diluted glycol sample. The diluted glycol sample may move through the column 134 in a carrier gas. The carrier gas is supplied by a gas supply 130. The carrier gas may be any inert gas known for use in gas chromatography. Examples of carrier gas may include nitrogen gas, helium gas, and combinations thereof.

The column 134 may be any chromatographic column that provides sufficient separation. Sufficient separation is determined from column variables such as length, internal diameter, film thickness, and combinations thereof. In one or more embodiments, the column 134 is a nonpolar 100% dimethylpolysiloxane column with a length of 50 meters, internal diameter of 0.2 millimeters, and a film thickness of 0.5 microns.

The column 134 may be enclosed in an oven 132. The oven 132 may be at a static temperature or the temperature may be varied. The temperature may be varied by a temperature ramping program. In one or more embodiments, the oven is at a temperature in the range of 170 to 220° C.

The gas chromatography instrument 124 may be configured to direct the glycol sample from the column 134 into a detector 136 (e.g., via a pathway or by providing the detector in fluid communication with the column 134). The detector converts the number of MEG or TEG molecules present in the glycol sample to an electrical signal. The detector may be any known detector for use with gas chromatography. In one or more embodiments, the detector is a flame-ionization detector (FID). The FID may use a flame to heat the glycol sample, where the resulting gaseous molecules of MEG or TEG in the glycol sample are converted by the FID to an electric signal. Fuel gases for the flame of the FID may be a mix of air and hydrogen gas at a ratio of 10:1 air to hydrogen gas. The temperature of the FID may be in a range from 250 to 300° C. In one or more embodiments, the temperature of the FID is at 250° C. The detector 136 may be connected to a recorder 138 to display the data from the gas chromatography instrument 124.

The system 100 may also be aligned to flow glycol through test lines 140 and 144 by the opening of 3-way valve 142. Test line 144 may be positioned to feed glycol to the evaporation instrument 146. The evaporation instrument 146 may be configured to direct glycol into an evaporation unit 147. The evaporation instrument 146 may be placed at any known location onsite that allows for test line 144 to feed the glycol to the evaporation instrument 146.

The evaporation unit 147 may have a sample chamber. The sample chamber may have a capacity of 250 milliliters. The evaporation instrument 146 may be configured to feed 100 milliliters of glycol sample into the sample chamber. The evaporation unit 147 may also be configured to heat the glycol sample, e.g., using a heater provided with the evaporation instrument 146. Heating the glycol sample will evaporate the impurities so that pure MEG or pure TEG remains in the sample chamber. The heating temperature may range from 50 to 150° C. In one or more embodiments, the glycol sample is heated to a temperature in the range of 120 to 130° C. The glycol sample may be heated in the sample chamber for a period of time. The period of time may range from 15 to 60 minutes. In one or more embodiments, the period of time is 60 minutes.

Test line 148 may be fluidly connected between the evaporation unit 147 and a volume apparatus 149 to move the glycol sample from the evaporation unit 147 to the volume apparatus 149. The volume apparatus 149 may be designed to measure the volume of the glycol sample after evaporation in the sample chamber, e.g., using a level sensor or other volume measurement device and/or technique. In other embodiments, the evaporation unit 147 may have a volume measurement feature incorporated therein. For example, a heated tube in an evaporation unit may include a level sensor or other volume measurement device. In such embodiments, a volume apparatus may not be a separate apparatus from the evaporation unit. In some embodiments, an evaporation unit and/or a volume apparatus may include a level controller, which may monitor and control the level of fluid therein.

The system 100 may also be aligned to flow glycol through test line 150 by the opening of 3-way valve 142. Test line 150 may be positioned to feed glycol from test line 140 to the titration instrument 152. The titration instrument 152 may be placed at any known location onsite that allows for test lines 140 and 150 to feed the glycol to the titration instrument 152. In one or more embodiments, the system is configured so that the gas chromatography instrument 124, the evaporation instrument 146, and the titration instrument 152 are positioned in parallel.

In one or more embodiments, the titration instrument 152 is a Karl Fischer titration instrument. Karl Fischer titration is a known titration method to determine the percent by weight (wt %) of water in a sample. The purity results from subtracting the water wt % from 100%. The titration instrument 152 may be configured with a titration vessel 160 that the glycol sample is fed to. The titration vessel 160 may contain an amount of the glycol sample. The amount may be in a range from 0.05 to 0.5 grams. In one or more embodiments, the amount is 0.5 grams. The titration vessel 160 may also contain a measurement solution. The measurement solution may include a mixture of chloroform and methanol. In one or more embodiments, the mixture of chloroform and methanol is at a ratio of 3 parts chloroform to one part methanol.

A titration apparatus 154 may be configured to supply titrant to the titration vessel 160. The titrant may be a Karl Fischer reagent. An example of the Karl Fischer reagent may include Composite 5 reagent (Hydranal). Composite 5 reagent may include imidiazoles, sulfur dioxide, and iodine in a diethylene glycol mono-ethyl-ether (DEGEE) solvent. Communication line 156 may lead to a data processing and control unit 158 and detection unit 164. The communication line 156 is configured to control the addition of the titrant via the data processing and control unit 158 to the titration vessel 160. The communication line 156 is also configured to detect the end point of the titration via the detection unit 164 in the titration vessel 160. The data processing and control unit 158 are also configured to calculate the purity of the glycol sample by subtracting the water wt % from 100%.

The system 100 may also be configured to flow glycol through test lines 108 and 112 by opening manual valve 110 and 113 and 4-way valve 114 to drain line 180. The drain line 180 may be needed to collect an offline sample. The drain line 180 may also be used in a flushing process to provide a representative glycol sample from the measurement of each described testing equipment.

The system 100 may be configured to use an interfacial online data processor 166. The interfacial online data processor 166 may be in communication with the gas chromatography instrument 124 through communication line 168. The interfacial online data processor 166 may also be in communication with the evaporation instrument 146 through communication line 170. The interfacial online data processor may further be in communication with the titration instrument 152 through communication line 172. The interfacial online data processor 166 may transmit data (e.g., measurement data) individually from only one testing instrument to a distributed control system (DCS). The interfacial online data processor 166 may also transmit all the data from all three testing instruments to the DCS. The data may be transmitted separated by instrument or averaged together. The data may be transmitted in real-time to an operation team. The operation team may review the data transmitted by the DCS and take any action required to prevent gas hydrate formation. Real-time transmittance may provide for rapid action to prevent the unsafe formation of the hydrates.

As illustrated in FIG. 1, the system may include various additional valves (e.g., valve 176) and pressure indicators (e.g., 174 and 178) for isolating, controlling, and/or monitoring the glycol flow through the pipeline 102.

The system 100 may be configured to monitor for the continuous injection of MEG at an offshore facility. The system 100 may also be configured to monitor that the TEG purity is equal to or greater than 98.5%. The purity of the glycol sample may be measured in a manner that results in real-time determination of the purity. Real-time determination of the purity may enhance the gas dehydration process by providing the operation team the data to know when action is needed to meet the purity requirements. Actions such as adjusting a TEG column flow in a gas dehydration system and/or adjusting the reboiler temperature may be taken to meet the TEG purity requirement.

Embodiments disclosed herein relate to methods for measuring a purity of a glycol sample. The methods may include measuring the purity of the glycol sample using three techniques. The three techniques may include gas chromatography, evaporation, and titration. The methods may include, after measuring the purity of the glycol sample, comparing the results from the three techniques to obtain an accurate purity of the glycol sample. The glycol sample may be taken from a glycol pipeline used in the gas production industry. The glycol sample may contain monoethylene glycol (MEG) or triethylene glycol (TEG). Methods according to embodiments of the present disclosure may include measuring the purity of the glycol sample using at least one of three disclosed techniques in an offline system (where samples are collected and tested separately in testing equipment disconnected from the glycol feed line, e.g., in a lab) and/or in an online system, such as shown in FIG. 1 (where samples are directed from a glycol feed line to one or more of the testing equipment via fluidly connected test lines).

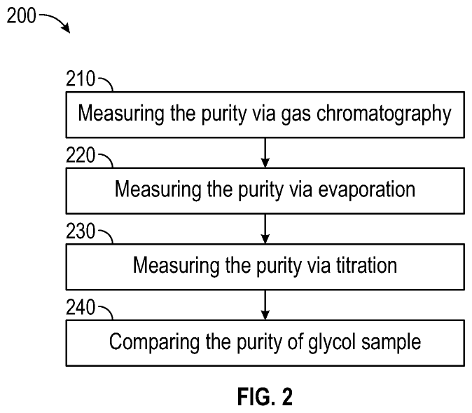

FIG. 2 is a flowchart of a method for determining a purity of a glycol sample, according to one or more embodiments. The method depicted in FIG. 2 may occur using offline systems, which is different from the online systems shown in FIG. 1. At block 210, the method 200 includes the step of measuring the purity of the glycol sample via gas chromatography. The glycol sample may be collected in a clean and dry container from the pipeline. The container for sample collection is required to be dry to prevent additional water from entering the glycol sample. The glycol sample may be measured via gas chromatography within 24 hours of the sample being collected. Measuring the sample within 24 hours may be required to prevent additional water from entering the glycol sample.

In one or more embodiments, measuring the purity of the glycol sample via gas chromatography includes diluting the sample. Diluting is required to reduce the concentration of glycol to a level that is compatible with the gas chromatography instrument. Diluting the glycol sample may use deionized water as the solvent. The dilution may be done in a range of 5 to 20 fold by volume. A 20 fold dilution, for example, is when the glycol is diluted by a factor of 20 by volume in deionized water.

In one or more embodiments, after diluting, the glycol sample is injected into a gas chromatography instrument. The gas chromatography instrument may be any known gas chromatography instrument capable of separating the glycol sample. According to one or more embodiments, the gas chromatography instrument is an Agilent 7890 A. The glycol sample may be injected using an autosampler. In other embodiments, the glycol sample may be injected manually. Injecting the glycol sample may occur by using a 10 μL glass chromatography syringe. The volume for the injection may be in a range of 0.5 to 2 μL of the diluted glycol sample. The injection may be split or splitless. The split injection may occur at a ratio in a range that may be chosen based on the instrument capability. For example, the split injection may occur at a ratio of from 1:1 to 1:100, for example 1:1, 1:50, or 1:100.

After injecting, the method 200 may include separating the pure glycol from the glycol sample via the gas chromatography instrument. In one or more embodiments, the pure glycol is MEG. In other embodiments, the pure glycol is TEG. Separating the pure glycol from the glycol sample may occur in a column. Separating is based upon the affinity of the pure glycol with the column. Separating is also based on the boiling point of the pure glycol. According to one or more embodiments, the column is a nonpolar 100% dimethylpolysiloxane column with a length of 50 meters, internal diameter of 0.2 millimeters, and a film thickness of 0.5 microns.

Separating the pure glycol from the glycol sample may include a carrier gas. The carrier gas flows through the gas chromatography instrument and acts as a solvent to carry the glycol sample through the column. The carrier gas may be any inert gas known for use in gas chromatography. Examples of carrier gas may include nitrogen gas, helium gas. hydrogen gas, and combinations thereof. In one or more embodiments, the carrier gas is helium. The carrier gas may have a flow rate. The flow rate may range from 1 to 30 milliliters per minute (mL/min).

The column may be heated during separation. The separating may include heating the glycol sample to reach the boiling point of the pure glycol in the glycol sample. According to one or more embodiments, heating the column occurs in an oven. The oven may be at a static temperature, or the temperature may be varied. The temperature may be varied by a temperature ramping program. The temperature ramping program may increase the temperature of the oven and the column an amount of temperature over a period of time. The ramping program may include a rate of about 5° C./min to 20° C./min, where the ramping rate may be lower or higher, depending on the gas chromatography instrument capability.

The pure glycol in the glycol sample may be analyzed by a detector in the gas chromatography instrument. In one or more embodiments, the detector is a flame ionization detector (FID). The pure glycol in the glycol sample, after separating from the column, may be ionized. Ionizing may be done by an electron beam. Once ionized, the pure glycol molecules may be analyzed by the FID. Analyzing may require the FID to be heated. Heating may be achieved through the flame of the FID. The temperature of the flame of the FID may be in a range of 250 to 300° C.

The FID may convert the number of ionized pure glycol molecules to an intensity. The intensity may be graphed versus the retention time in a chromatogram. The chromatogram is how separation by a gas chromatography instrument is quantified. The retention time is the amount of time the components of a sample require to separate from the column. Retention times are unique to the component and the gas chromatography instrument. The retention time may be used to identify the component. The intensity is a measure of the number of ionized molecules at a particular retention time.

In one or more embodiments, the purity of a glycol sample is measured via gas chromatography by comparing the peak area of the intensity of MEG or TEG to a calibration curve. Each glycol derivative may require a separate calibration curve. For MEG, the calibration curve may involve samples of pure MEG measured by gas chromatography as previously described. The samples of pure MEG may be prepared at known purities. In one or more embodiments, a minimum of four samples of pure MEG of known purities in the range of 1 to 10 percent by weight (wt %) are needed for the calibration curve for MEG. The samples of pure MEG may be dissolved in distilled or deionized water. The known purities of MEG may be graphed on an x-axis of a graph. The peak area that results from measuring via the gas chromatography instrument for each known purity of MEG may be graphed on a y-axis of the same graph. Graphing may be done with basic software, such as Excel.

For TEG, the calibration curve may involve samples of pure TEG measured by gas chromatography as previously described. The samples of pure TEG may be prepared at known purities. In one or more embodiments, a minimum of three samples of pure MEG of known purities in the range of 0.5 to 2 percent by weight (wt %) are needed for the calibration curve for MEG. The samples of pure TEG may be dissolved in distilled or deionized water. The known purities of TEG may be graphed on an x-axis of a graph. The peak area that results from measuring via the gas chromatography instrument for each known purity of TEG may be graphed on a y-axis of the same graph. Graphing may be done with basic software, such as Excel.

A linear line may be determined from each graph. One linear line will correlate a peak area of MEG (y-value) with a purity of MEG (x-value). The other linear line will correlate the peak area of TEG (y-value) with a purity of TEG (x-value). Determining the linear equation may include applying a linear least squares analysis to each graph. The linear least squares analysis may result in the linear equation. Determining the linear equation may require basic software programs, such as Excel. The linear least squares analysis may further result in a R² value, where the R² value relates to the strength of the linear equation. A R² value of 0.90 or greater may relate to a strong linear correlation.

According to one or more embodiments, applying the linear equation that results from the linear least squares analysis yields the unknown purity of a glycol sample. The linear equation from the graph of known MEG purities yields the unknown purity of the glycol sample including MEG. The linear equation from the graph of known TEG purities yields the unknown purity of the glycol sample including TEG. The peak area from the glycol sample of unknown purity may be input into the linear equation as the y-value. Then, solving the equation for the x-value will yield the purity.

At block 220, the method 200 includes the step of measuring the purity of the glycol sample via evaporation. Evaporating may first include centrifuging the glycol sample to remove any suspended solids. Centrifuging may be done at any known speed and period of time needed to separate the glycol sample from suspended solids. After centrifuging, the glycol sample may be removed from the aggregated solids and prepared for evaporation.

Evaporating water from the glycol sample, in one or more embodiments, is done by distilling the glycol sample. Distilling may use a distillation apparatus. The distillation apparatus may include a rounded flask that is heated and stirred. The distillation apparatus may also include a condenser connected to the receptor flask. The condenser may collect water and hydrocarbons that evaporate from the glycol sample. The glycol sample may be placed in the rounded flask and heated for a period of time. Distilling may occur at a temperature in a range from 50 to 150° C. Distilling may occur over a period of time from 15 to 60 minutes. Distilling may produce a distilled volume of the glycol sample which corresponds to a pure volume of the glycol sample.

After evaporating, the method of measuring the purity of a glycol sample includes comparing the remaining volume of the glycol sample in the flask to the original volume of the glycol sample before distilling. Comparing the volume may use a calibrated graduated cylinder where the distilled volume resulting from evaporating is measured at room temperature (i.e., 25° C.). The graduated cylinder may be calibrated by a certified calibration laboratory. According to one or more embodiments, the purity from comparing the volume is measured using Equation 1.

$$Purity ( wt \% ) = ( \frac{{V}_{2}}{{V}_{1}} \times 100 \% ) \times d \qquad ( Equation 1 )$$

In Equation 1, V₂ corresponds to the distilled volume while V₁ corresponds to the original volume. d corresponds to the density of the glycol derivative in the glycol sample. The density may be the density for MEG or TEG, depending on which glycol derivative is being measured. The density of MEG may be 1.10 g/cm³. The density of TEG may be 1.12 g/cm³. In one or more embodiments, applying Equation 1 yields the purity of the glycol sample via evaporation.

At block 230, the method includes the step of measuring the purity of the glycol sample via titration. According to one or more embodiments, the titration is a Karl Fischer titration. Titrating may occur by using a Karl Fischer volumetric titrator. Karl Fischer titrating is a known method for determining the amount of water in a sample. In such titrations, the sample is titrated with a known concentration of an iodine solution where the water in the sample will react stoichiometrically based on the reaction below.

2H₂O+SO₂+I₂→H₂SO₄+2HI

In one or more embodiments, titrating the glycol sample involves adding a volume of a known concentration of iodine solution to a volume of the glycol sample. Based on the reaction above, the iodine will react with the water in the glycol sample. The endpoint may be determined potentiometrically where an excess of iodine will lead to a potential change. The endpoint indicates that the water in the glycol sample has been completely reacted with the iodine solution. A stoichiometric calculation using the volume of the iodine solution, the known concentration of the iodine solution, and the volume of the glycol sample may produce the water percent by weight (wt %) of the glycol sample. In one or more embodiments, the purity of the glycol sample is calculated by Equation 2.

$$Purity ( wt \% ) = 100 \% - Water ( wt \% ) \qquad ( Equation 2 )$$

According to one or more embodiments, the glycol sample contains H₂S. H₂S may cause a positive interference when measuring the purity of the glycol sample via titration. A positive interference may result in the purity of the glycol sample being higher than is accurate. To overcome the positive interference, the H₂S content of the glycol sample may be measured. The H₂S content may be measured by a potentiometric titration with silver nitrate, which reacts according to the reaction below. Once the H₂S content is measured, the positive interference may be overcome by applying Equation 3 after titrating.

$${H}_{2} S ( g ) + 2 {AgNO}_{3} ( aq ) \to 2 {HNO}_{3} ( aq ) + {Ag}_{2} S ( s ) \\ Purity ( wt \% ) = 100 \% - ( Water ( wt \% ) - {H}_{2} S ( wt \% ) ) \qquad ( Equation 3 )$$

Although blocks 210, 220, and 230 are described in method 200 sequentially, in the present disclosure, measuring the purity of the glycol sample may be done in any order or simultaneously. That is, block 220 of measuring the purity of the glycol sample via evaporation may be done before block 210, after block 230, or during block 210 and/or 230. Similarly, block 230 of measuring the purity of the glycol sample via titration may be done before block 210, before block 220, or during block 210 and/or 220.

At block 240, the method 200 includes the step of comparing the purity of the glycol sample from blocks 210, 220, and 230. Comparing the purity of the glycol sample yielded from gas chromatography, evaporation, and titration may provide confirmation of an accurate purity. A table may be used to compare the purity as measured in wt %. The allowable difference between the measurements may be in a range from 10 to 15 wt % different.

Embodiments of the present disclosure may provide at least one of the following advantages. The system for measuring the purity of a glycol sample may be operated continuously. Current methods known in the art tend to require additional sampling and analysis time due to the glycol sample needing transported to a separate facility for measuring. These current methods tend to also have additional delays if rough weather occurs at offshore facilities in the gas production industry. The system described herein allows for the sampling and measuring to be done in real-time. The real-time determination may lead to a more rapid measuring of the purity of the glycol. The real-time determination may prevent unplanned shutdowns due to hydrate formation because an inaccurate purity of glycol was used.

Another advantage of embodiments of the present disclosure is that the method may provide a three-fold measurement of accuracy of the purity of the glycol sample. Current methods known in the art tend to measure the purity of a glycol sample using one technique. Methods as described in the present disclosure use three techniques. The use of three techniques may result in a three-fold verification that the purity of the glycol sample is measured accurately. Accuracy may prevent the use of a low strength glycol sample. Low strength glycol in the gas production industry may lead to pipeline blockage due to hydrate formation. Low strength glycol may also lead to glycol losses during glycol transportation.

Another advantage of embodiments of the present disclosure is based on the column used in the system and method of measuring the purity of a glycol sample via gas chromatography. Current methods known in the art tend to use a column that requires a long conditioning time. A long conditioning time may be a period of time spanning three to four weeks. Examples of columns used by current methods known in the art may be a CP-WAX or a Telfon column. Further, current methods known in the art tend to use a column that has known interferences with chemicals found in a pipeline containing glycol, such as corrosion inhibitors and pH optimizers. Embodiments of the present disclosure include a dimethylpolysiloxane column. The dimethylpolysiloxane column, as described herein, does not require any conditioning. The dimethylpolysiloxane column may accurately separate the derivatives of glycol with a low level of noise without any interference from corrosion inhibitors and pH optimizers. The use of the dimethylpolysiloxane column may result in a more accurate and a more rapid measuring of the purity of the glycol sample.

An additional advantage of the present disclosure related to the use of the dimethylpolysiloxane column is that the method described herein may also be used to provide detailed hydrocarbon concentration measurements from the glycol sample. Hydrocarbons may be dissolved in the glycol sample. These hydrocarbons (e.g., benzene, toluene, ethyl benzene, and xylene (BTEX)) may be detected using a dimethylpolysiloxane column as distinct peaks. Current methods in the art tend to use a column that is unable to separate these hydrocarbons. The method described herein has superior separation ability with respect to the glycol sample, so that not only are the glycol derivatives effectively separated, but other components of the sample, such as hydrocarbons, are as well.

A further advantage of embodiments of the present disclosure is that methods described herein are capable of detecting a wide range of purities in a glycol sample. Current methods in the art tend to detect the purity in a range of ppm and up to a partial percentage level. The methods, as described herein, may detect a purity range in glycol sample from trace levels (ppb) up to 100 wt %.

### EXAMPLES

### Procedure 1: Gas Chromatography Technique

The glycol samples were collected in a clean and dry 250 ml plastic bottle. The glycol sample was analyzed within 24 hours to avoid adsorbing moisture from the atmosphere.

The gas chromatography instrument was run as listed below, following the described detailed operating parameters: an Agilent 7890 A Gas Chromatograph with FID detector for hydrocarbons determination was used. The oven used had temperature control for temperature programing, Helium (with a 99.99% purity) was used as the carrier gas, and HP-PONA (100% Dimethylpolysiloxane) separated column (50 m, 0.2 mm internal diameter and 0.5 μm film thickness) was used as the column. The column pressure was 21.6 psi. The flame ionization detector was set to 250° C. The injector was a split/splitless injector set to 250° C. with a split ratio of 70. The oven temperature program was set to an initial temperature of 170° C. for 5 minutes. Then the program increased at 20° C. per minute up to 200° C. The total run time for the gas chromatography instrument was 20 minutes. A 10 μL glass syringe was used to inject 0.5-2 μL of the glycol sample. The results were calculated automatically by the software within 20 minutes. A dilution factor was applied to any diluted samples to get the accurate purity for a high purity glycol sample greater than 10%.

Standard preparation: Samples of a pure glycol derivative at known purities were prepared to generate a calibration curve. The pure glycol derivatives were MEG and TEG. Three different concentrations of MEG and TEG were prepared by using fresh MEG and TEG (99.9%), which were previously dehydrated at 110° C. and dried in a desiccator for one hour. The purity of the TEG was confirmed by determining the moisture content using Karl Fischer volumetric titration. The calibration standards were prepared by adding 0.5, 1.0, and 2.0 grams of the fresh TEG and 1, 2, 5, & 10 grams of fresh MEG and then diluting to 100 grams with distilled water. Due to the miscibility of glycols in water, the MEG and TEG were dissolved in the water to form a homogenous liquid phase.

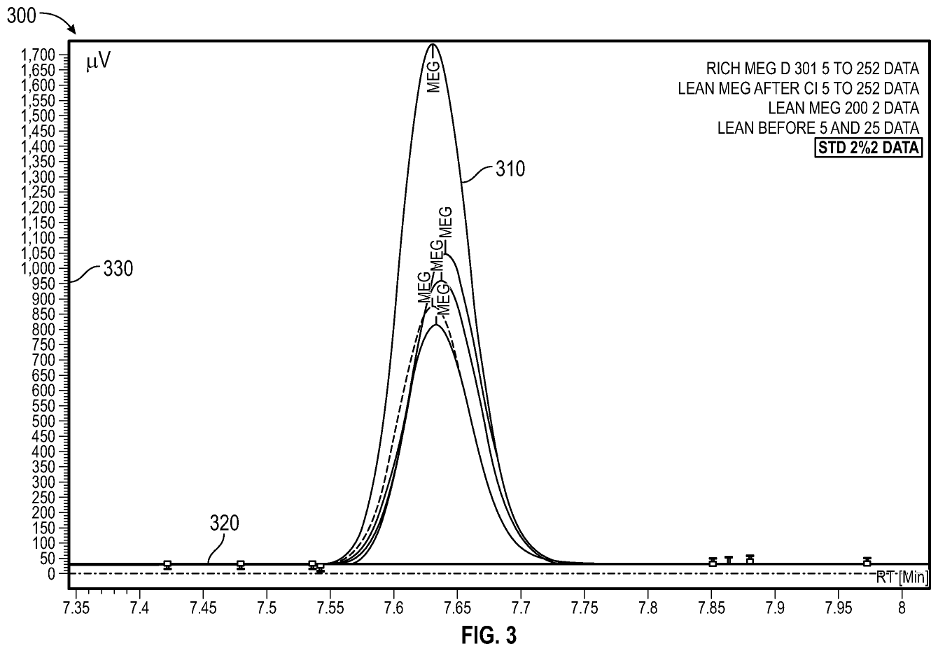

FIG. 3 is an example of a plurality of peak areas 310 from samples of MEG of known purity, in accordance with one or more embodiments. The peak areas are overlaid to show that peak area increases with concentration. FIG. 3 includes an x-axis 320 of retention time in minutes. FIG. 3 also includes a y-axis 330 of intensity in u V.

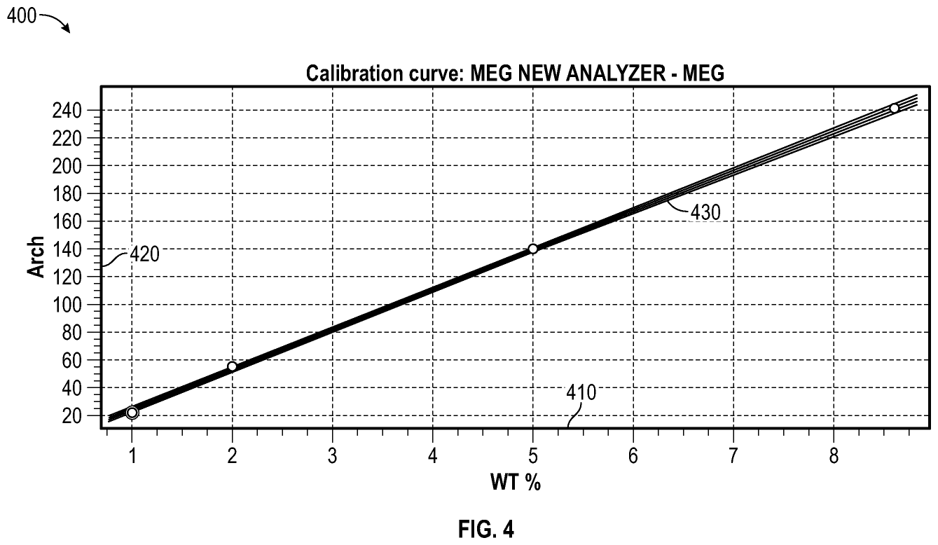

FIG. 4 is an example calibration curve for MEG based on the plurality of peak areas from FIG. 3, in accordance with one or more embodiments. The graph 400 has an x-axis 410 of MEG purity in wt %. The graph 400 has a y-axis 420 of peak area. Linear least squares analysis results in a linear line 430, producing an equation to relate a peak area to an unknown purity of MEG.

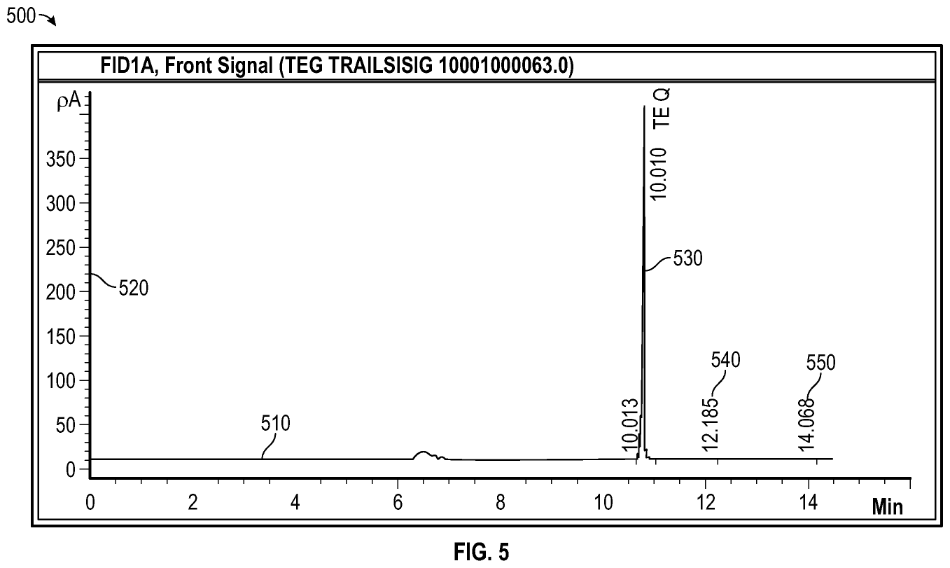

FIG. 5 is an example gas chromatograph of TEG, in accordance with one or more embodiments. FIG. 5 includes an x-axis 510 of retention time in minutes. FIG. 5 includes a y-axis 520 of intensity in pA. FIG. 5 shows peaks 530, 540, and 550. Peak 530 is the peak corresponding to TEG. Peaks 540 and 550 are associated hydrocarbons (e.g., benzene, toluene, ethyl benzene, and xylene (BTEX)).

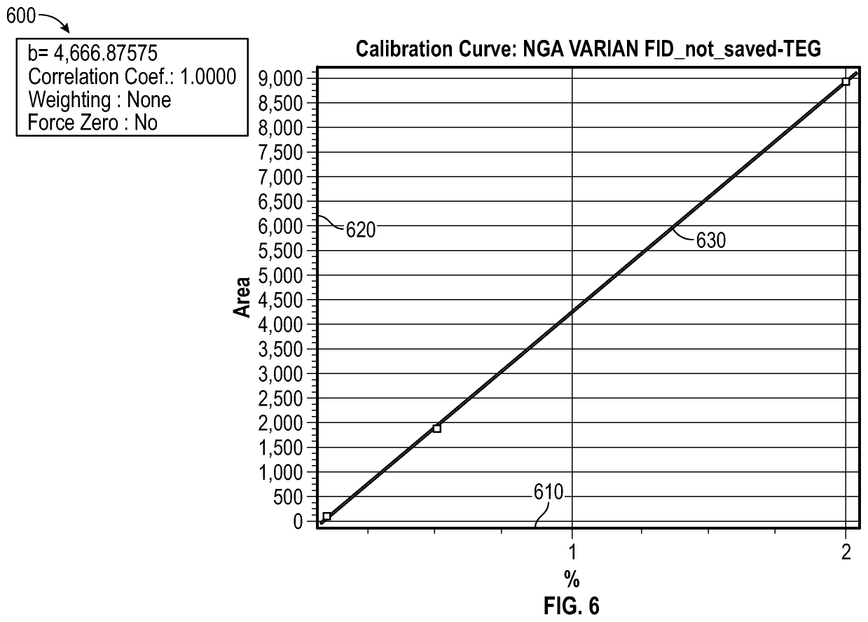

FIG. 6 is an example calibration curve for TEG, in accordance with one or more embodiments. The graph 600 has an x-axis 610 of TEG purity in wt %. The graph 600 has a y-axis 620 of peak area. Linear least squares analysis results in a linear line 630, producing an equation to relate a peak area to an unknown purity of TEG.

### Procedure 2: Evaporation Technique

A 100 mL sample of glycol was centrifuged at 800 rpm to separate the hydrocarbons and glycol from the undesirable suspended solids. Separation may also occur with a separated funnel to collect the glycol from a two layer glycol sample (i.e., MEG and Hydrocarbon).

Sample analysis was conducted as follows: a 100 mL sample was placed in a distillation apparatus including a 250 mL rounded flask on a heater with stirrer attached with condenser, which was connected to a receptor flask to collect distillate. An isothermal program was deployed at 125-130° C. for 1 hour and the remaining volume measured by calibrated graduated cylinder at room temperature. The remaining volume reflected the MEG % and the received solution at the receptor flask reflected the amount of water and the dissolved hydrocarbons percentage.

Table 1, below, is a comparison between MEG wt % results by the gas chromatography technique and the evaporation technique.

TABLE 1

| | | New Evaporation | |
|---|---|---|---|
| | | Method by | |
| | GC Method | BUCHI Digest | |
| Sample Source | MEG wt % | Unit MEG wt % | Difference |
| Lean MEG Sample | 12.2 | 12.0 | 0.2 |
| Rich MEG Sample | 6.5 | 6.0 | 0.5 |
| MEG Sample 3 | 9.6 | 10.0 | 0.4 |
| MEG Sample 4 | 72.0 | 73.0 | 1.0 |

### Procedure 3: Titration Technique

A glycol sample was separated by a separatory funnel when the received sample contained two layers, one of glycol and one of hydrocarbons. The sample was analyzed by a Karl Fischer volumetric titrator and the MEG % calculated using the below equation.

$$MEG ( wt \% ) = 100 - ( Water \% from Karl Fischer titrator )$$

Table 2, below, is a comparison between MEG wt % results by the gas chromatography technique and the water content determined by the titration technique.

TABLE 2

| | | Balanced | MEG wt | |
|---|---|---|---|---|
| | Water | MEG wt % | % by Gas | |
| | Content | by Water | Chroma- | |
| Sample Date | wt % | Content | tography | Difference |
| Lean MEG (Sample 1) | 83.2 | 16.8 | 16.00 | 0.8 |
| Lean MEG (Sample 2) | 65.2 | 34.8 | 36.00 | 1.2 |
| Lean MEG (Sample 3) | 84.8 | 15.2 | 17.00 | 1.8 |
| Lean MEG (Sample 4) | 83.4 | 16.6 | 18.30 | 1.7 |
| Lean MEG (Sample 5) | 84.0 | 16 | 17.20 | 1.2 |
| Lean MEG (Sample 6) | 65.3 | 34.7 | 35.70 | 1.0 |
| Lean MEG (Sample 7) | 58.1 | 41.9 | 43.20 | 1.3 |

Table 3, below, is a comparison between TEG wt % results by the gas chromatography technique and the water content determined by the titration technique.

TABLE 3

| | | TEG wt % | | |
|---|---|---|---|---|
| | Water | Balanced | TEG wt | |
| | Content | by Water | % by Gas | |
| Sample Location | wt % | Content | Chromatography | Difference |
| Rich glycol inlet | 14.19 | 85.81 | 84.9 | 0.91 |
| Rich glycol | 13.77 | 86.23 | 87.01 | 0.78 |
| Rich glycol | 14.14 | 85.86 | 86.5 | 0.64 |
| Rich glycol | 14.66 | 85.34 | 85.01 | 0.03 |
| Lean TEG | 13.33 | 86.67 | 86.2 | 0.47 |

Table 4, below, is comparison of samples that were analyzed by GC using a 100% dimethylpolysiloxane column (NATSD Lab Supply) against the traditional technique of a CP-WAX column (Lab 2 Supply) and all the reported values were within only 10% deviation as tabulated below.

TABLE 4

| | | NATSD | Lab 2 | |
|---|---|---|---|---|
| Sampling | | Lab Supply | Supply MEG | Difference |
| Location | Sampling Date | MEG (wt %) | (wt %) | (wt %) |
| Field MEG | Nov. 6, 2019 | 16.00 | 13.40 | 2.60 |
| samples | Nov. 7, 2019 | 36.00 | 34.20 | 1.80 |
| | Nov. 8, 2019 | 17.00 | 15.50 | 1.50 |
| | Nov. 9, 2019 | 18.30 | 17.30 | 1.00 |
| | Nov. 10, 2019 | 17.20 | 15.90 | 1.30 |
| | Nov. 11, 2019 | 35.70 | 35.30 | 0.40 |
| | Nov. 14, 2019 | 43.20 | 38.70 | 4.50 |
| | Nov. 15, 2019 | 16.00 | 14.30 | 1.70 |
| | Nov. 16, 2019 | 12.40 | 9.80 | 2.60 |
| | Nov. 27, 2019 | 30.40 | 36.60 | 6.20 |
| | Nov. 27, 2019 | 22.80 | 20.26 | 2.54 |
| | Nov. 28, 2019 | 26.32 | 29.60 | 3.28 |
| | Nov. 28, 2019 | 28.15 | 30.70 | 2.55 |
| | Nov. 28, 2019 | 22.60 | 21.78 | 0.82 |
| | Dec. 12, 2019 | 46.60 | 44.50 | 2.10 |
| | Dec. 14, 2019 | 48.20 | 49.60 | 1.40 |
| | Dec. 20, 2019 | 17.65 | 21.80 | 4.15 |
| | Dec. 22, 2019 | 21.45 | 22.30 | 0.85 |
| | Dec. 23, 2019 | 19.84 | 22.00 | 2.16 |
| | Dec. 28, 2019 | 43.20 | 40.40 | 2.80 |
| | Dec. 29, 2019 | 39.40 | 38.00 | 1.40 |
| | Dec. 30, 2019 | 40.20 | 37.00 | 3.20 |
| | Dec. 31, 2019 | 35.10 | 35.90 | 0.80 |
| | Jan. 2, 2020 | 49.50 | 53.60 | 4.10 |
| | Jan. 3, 2020 | 54.20 | 58.30 | 4.10 |
| | Jan. 13, 2020 | 37.00 | 33.40 | 3.60 |
| | Jan. 14, 2020 | 40.50 | 35.20 | 5.30 |
| | Jan. 16, 2020 | 52.00 | 46.20 | 5.80 |
| | Jan. 21, 2020 | 43.60 | 45.90 | 2.30 |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for measuring a purity of a glycol sample, the method comprising:
measuring the purity of the glycol sample via gas chromatography;
measuring the purity of the glycol sample via evaporation;
measuring the purity of the glycol sample via titration, and
comparing the purity of the glycol sample from gas chromatography, evaporation, and titration to obtain an accurate purity.

2. The method of claim 1, wherein the glycol sample comprises monoethylene glycol.

3. The method of claim 1, wherein the glycol sample comprises triethylene glycol.

4. The method of claim 1, wherein measuring the purity of the glycol sample via gas chromatography comprises separating the glycol sample with a dimethylpolysiloxane column.

5. The method of claim 1, wherein measuring the purity of the glycol sample via gas chromatography comprises detecting the purity of the glycol sample by a flame ionization detector.

6. The method of claim 1, wherein measuring the purity of the glycol sample via evaporation comprises distillation of the glycol sample.

7. The method of claim 6, wherein measuring the purity of the glycol sample via evaporation comprises comparing a distilled volume of the glycol sample to an original volume of the glycol sample.

8. The method of claim 1, wherein measuring the purity of the glycol sample via titration comprises titrating the glycol sample by a Karl Fischer titration.

9. A system for measuring a purity of a glycol sample in a pipeline, the system comprising:
at least one type of testing equipment connected to the pipeline via at least one test line,
the at least one type of testing equipment comprising:
a gas chromatography instrument;
an evaporation instrument; and
a titration instrument; and
an interfacial online data processor in communication with the at least one type of testing equipment.

10. The system of claim 9, wherein the glycol sample comprises monoethylene glycol.

11. The system of claim 9, wherein the glycol sample comprises triethylene glycol.

12. The system of claim 9, wherein one of the at least one test line feeds to an evaporation instrument for measuring the purity of the glycol sample.

13. The system of claim 12, wherein the evaporation instrument is a distillation instrument.

14. The system of claim 9, wherein one of the at least one test line feeds to a titration instrument for measuring the purity of the glycol sample.

15. The system of claim 14, wherein the titration instrument is a Karl Fischer volumetric titrator.

16. The system of claim 9, wherein the gas chromatography instrument comprises a dimethylpolysiloxane column.

17. The system of claim 9, wherein the gas chromatography instrument includes a flame ionization detector.

18. The system of claim 9, wherein the interfacial online data processor transmits the purity of the glycol sample from the at least one type of testing equipment to a distributed control system.

19. The system of claim 18, wherein the interfacial online data processor transmits the purity of the glycol sample individually from each of the at least one type of testing equipment.

20. The system of claim 18. wherein the interfacial online data processor transmits the purity of the glycol sample as an average from all of the at least one type of testing equipment.
